(19) United States
(12) Patent Application Publication
(10) Pub. No.: US 2026/0154239 A1
(43) Pub. Date: Jun. 4, 2026

(54) INFORMATION PROCESSING APPARATUS, INFORMATION PROCESSING METHOD, AND NON-TRANSITORY RECORDING MEDIUM

(71) Applicant: PFU LIMITED, Kahoku-shi (JP)

(72) Inventors: Kyoichi Nishi, Kahoku-shi (JP); Tomoaki Wada, Kahoku-shi (JP)

(21) Appl. No.: 19/390,292

(22) Filed: Nov. 14, 2025

(30) Foreign Application Priority Data
Nov. 29, 2024 (JP) 2024-208361

(51) Int. Cl. G06F 16/182; G06F 16/16

(52) U.S. Cl. CPC G06F 16/1824; G06F 16/162; G06F 16/164

(57) ABSTRACT

An information processing apparatus includes a memory that stores document data and metadata of the document data in association with each other, and circuitry to transmit the document data to a first storage service to store the document data in the first storage service, receive a storage location address of the document data from the first storage service, and transmit the metadata and the storage location address to a second storage service to store the metadata and the storage location address in the second storage service. The second storage service is different from the first storage service.

### CROSS-REFERENCE TO RELATED APPLICATIONS

This patent application is based on and claims priority pursuant to 35 U.S.C. § 119(a) to Japanese Patent Application No. 2024-208361, filed on Nov. 29, 2024, in the Japan Patent Office, the entire disclosure of which is hereby incorporated by reference herein.

### BACKGROUND

The present disclosure relates to an information processing apparatus, an information processing method, and a non-transitory recording medium.

There is a technique for a data file stored in a file server on a network to be viewed on a computer. For example, the computer reads a download address and management server authentication information from a link file, accesses a management server by using the management server authentication information, and obtains file server authentication information from the management server. The computer accesses the download address using the file server authentication information to retrieve the data file from the file server.

### SUMMARY

The information processing apparatus according to one aspect of the present disclosure includes a memory that stores document data and metadata of the document data in association with each other, and circuitry. The circuitry transmits the document data to a first storage service to store the document data in the first storage service, receives a storage location address of the document data from the first storage service, and transmits the metadata and the storage location address to a second storage service to store the metadata and the storage location address in the second storage service. The second storage service is different from the first storage service.

The information processing method according to another aspect of the present disclosure includes storing document data and metadata of the document data in association with each other, transmitting the document data to a first storage service to store the document data in the first storage service, receiving a storage location address of the document data from the first storage service, and transmitting the metadata and the storage location address to a second storage service to store the metadata and the storage location address in the second storage service. The second storage service is different from the first storage service.

The computer-readable, non-transitory recording medium according to still another aspect of the present disclosure stores a plurality of instructions which, when executed by one or more processors, causes the one or more processors to execute a process. The process includes storing document data and metadata of the document data in association with each other, transmitting the document data to a first storage service to store the document data in the first storage service, receiving a storage location address of the document data from the first storage service, and transmitting the metadata and the storage location address to a second storage service to store the metadata and the storage location address in the second storage service. The second storage service is different from the first storage service.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating a schematic configuration of an information processing system;

FIG. 2 is a block diagram illustrating a schematic configuration of a third memory and a third processing circuit;

FIG. 3 is a schematic diagram illustrating a data structure of a document data table;

FIG. 4 is a sequence diagram of a storage process;

FIG. 5 is a sequence diagram of an update process;

FIG. 6 is a sequence diagram of a deletion process;

FIG. 7 is a sequence diagram of a restoration process;

FIG. 8 is a sequence diagram of a synchronization process; and

FIG. 9 is a block diagram illustrating a schematic configuration of another third processing circuit.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

An information processing apparatus, an information processing method, and a control program are described below with reference to the drawings. The technical scope of the present disclosure is not limited to the embodiments described below and covers the equivalents of elements described below.

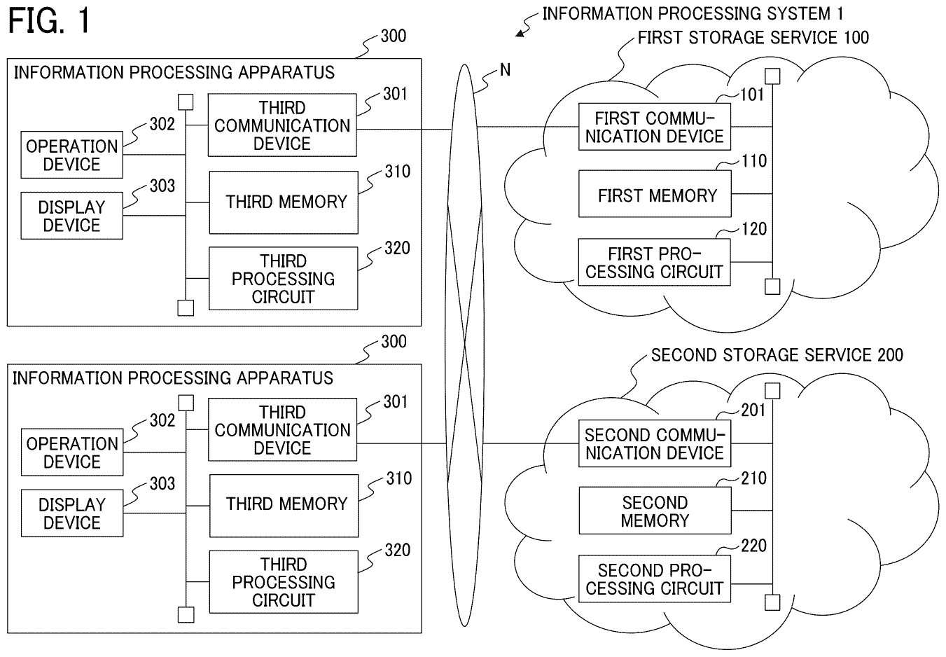

FIG. 1 is a diagram illustrating a schematic configuration of an information processing system 1.

The information processing system 1 provides document management software or document management services to manage and utilize document data. As illustrated in FIG. 1, the information processing system 1 includes a first storage service 100, a second storage service 200, and one or more information processing apparatuses 300. The first storage service 100, the second storage service 200, and the information processing apparatus 300 are connected to communicate with each other through a network N. The network N is, for example, the Internet or an intranet.

The first storage service 100 and the second storage service 200 are different storage services. Each of the first storage service 100 and the second storage service 200 includes one or more servers and provides a data storage service. Each of the first storage service 100 and the second storage service is, for example, a cloud service that has a cloud storage on a cloud network.

For example, the second storage service 200 is provided by the provider of the information processing apparatus 300, while the first storage service 100 is provided by a different provider than that of the information processing apparatus 300. Examples of the first storage service 100 in that case include Microsoft OneDrive®, Google Drive™, and Dropbox®.

The first storage service 100 is an object storage service that performs data storage and management, and the second storage service 200 may be a compute service that includes application servers and/or offers virtual machines. Examples of the first storage service 100 in that case include Amazon S3™, Google Cloud Storage™, and Microsoft Azure Blob Storage®. Examples of the second storage service 200 include Amazon EC2™, Google Compute Engine™, and Microsoft Virtual Machines®.

In this case, the first storage service 100 and the second storage service 200 may be provided by different providers.

The first storage service 100 includes a first communication device 101, a first memory 110, and a first processing circuit 120.

The first communication device 101 includes a wired communication interface circuit to transmit and receive signals through a wired communication line, such as a wired local area network (LAN), in compliance with a predetermined communication protocol. The first communication device 101 transmits and receives various data to and from the second storage service 200 and the information processing apparatus 300 according to an instruction from the first processing circuit 120. The first communication device 101 may include an antenna to transmit and receive wireless signals, and a wireless communication interface circuit to transmit and receive signals through a wireless communication line, such as a wireless LAN, in compliance with a predetermined communication protocol.

The first memory 110 includes memories such as a random-access memory (RAM) and a read-only memory (ROM), a fixed disk device such as a hard disk, or a portable memory such as a flexible disk or an optical disk. The first memory 110 stores data such as computer programs, databases, and tables used for various processes performed by the first storage service 100. The computer programs may be installed in the first memory 110 from a computer-readable portable recording medium using, for example, a setup program. The portable recording medium is, for example, a compact disc-read-only memory (CD-ROM) or a digital versatile disk-read-only memory (DVD-ROM). The computer programs may be distributed from a server or another distribution source and installed in the first memory 110.

The first processing circuit 120 operates according to a program stored in the first memory 110 in advance. The first processing circuit 120 is, for example, a central processing unit (CPU). The first processing circuit 120 may be implemented by a digital signal processor (DSP), a large-scale integration (LSI) circuit, an application-specific integrated circuit (ASIC), or a field-programmable gate array (FPGA).

The first processing circuit 120 is connected to the components such as the first communication device 101 and the first memory 110, and controls these components. The first processing circuit 120 controls the operations such as the transmission and reception of data with the information processing apparatus 300 via the first communication device 101, and the reading and writing of data from and to the first memory 110.

The second storage service 200 includes a second communication device 201, a second memory 210, and a second processing circuit 220.

The second communication device 201 includes a wired communication interface circuit to transmit and receive signals through a wired communication line, such as a wired LAN, in compliance with a predetermined communication protocol. The second communication device 201 transmits and receives various data to and from the first storage service 100 and the information processing apparatus 300 according to an instruction from the second processing circuit 220. The second communication device 201 may include an antenna to transmit and receive wireless signals, and a wireless communication interface circuit to transmit and receive signals through a wireless communication line, such as a wireless LAN, in compliance with a predetermined communication protocol.

The second memory 210 includes a memory such as a RAM and a ROM; a fixed disk device such as a hard disk; or a portable memory such as a flexible disk and an optical disk. The second memory 210 stores data such as computer programs, databases, and tables used for various processes performed by the second storage service 200. The computer programs may be installed in the second memory 210 from a computer-readable portable recording medium using, for example, a setup program. The portable recording medium is, for example, a CD-ROM or a DVD-ROM. The computer program may be distributed from a server or another distribution source and installed in the second memory 210.

The second processing circuit 220 operates according to a program stored in the second memory 210 in advance. For example, the second processing circuit 220 is a CPU. Alternatively, the second processing circuit 220 may be implemented by, for example, a DSP, an LSI, an ASIC, or an FPGA.

The second processing circuit 220 is connected to the components such as the second communication device 201 and the second memory 210, and controls these components. The second processing circuit 220 controls the operations such as the transmission and reception of data with the information processing apparatus 300 via the second communication device 201, and the reading and writing of data from and to the second memory 210.

The information processing apparatus 300 is, for example, a personal computer. The information processing apparatus 300 may be a server. Alternatively, the information processing apparatus 300 may be an image reading apparatus such as a scanner, a laptop personal computer, a tablet computer, a smartphone, or a mobile phone. The scanner includes a scanner with an automatic document feeder (ADF) to capture an image of a medium that is a document while conveying the medium, or a flatbed scanner to capture an image of a medium fixed in position. The media include paper sheets, cards, and booklets.

The information processing apparatus 300 includes a third communication device 301, an operation device 302, a display device 303, a third memory 310, and a third processing circuit 320.

The third communication device 301 may include a wired communication interface circuit to transmit and receive signals through a wired communication line, such as a wired LAN, in compliance with a predetermined communication protocol. The third communication device 301 transmits and receives various data to and from the first storage service 100 and the second storage service 200 according to an instruction from the third processing circuit 320. The third communication device 301 may include an antenna to transmit and receive wireless signals, and a wireless communication interface circuit to transmit and receive signals through a wireless communication line, such as a wireless LAN, in compliance with a predetermined communication protocol.

The operation device 302 includes input devices, such as a keyboard, a mouse, a button, and a touch screen, and an interface circuit that receives signals from the input devices. The operation device 302 receives operations from the user and outputs a signal corresponding to the user's operation to the third processing circuit 320.

The display device 303 includes a display, which may be a liquid crystal or organic electro-luminescence (EL) display, and an interface circuit that outputs image data to the display. The display device 303 displays various types of information, such as image data, on the display according to an instruction from the third processing circuit 320. The display device 303 may be omitted.

The third memory 310 is an example of a memory. The third memory 310 includes a memory such as a RAM and a ROM; a fixed disk device such as a hard disk; or a portable memory such as a flexible disk and an optical disk. The third memory 310 stores data such as computer programs, databases, and tables used for various processes performed by the information processing apparatus 300. The computer programs may be installed in the third memory 310 from a computer-readable portable recording medium using, for example, a setup program. The portable recording medium is, for example, a CD-ROM or a DVD-ROM. The computer programs may be distributed from a server or another distribution source and installed in the third memory 310. The third memory 310 stores a document data table. The document data table is described later in detail.

The third processing circuit 320 operates according to a program prestored in the third memory 310. For example, the third processing circuit 320 is a CPU. Alternatively, the second processing circuit 220 may be implemented by, for example, a DSP, an LSI, an ASIC, or an FPGA.

The third processing circuit 320 is connected to the components such as the third communication device 301, the operation device 302, the display device 303, and the third memory 310, and controls these components. The third processing circuit 320 controls the operations such as the data transmission and reception with the first storage service 100 and the second storage service 200 via the third communication device 301, and the reading and writing of data from and to the third memory 310.

When the information processing apparatus 300 is an image reading apparatus, the information processing apparatus 300 further includes an imaging device. The imaging device captures an image of a medium and generates an image of the medium. The imaging device includes an imaging sensor employing a reduction optical system and including charge-coupled device (CCD) imaging elements arranged in one dimension or two dimensions. The imaging device further includes a light source that emits light, a lens that forms an image on the imaging element, and an analog-to-digital (A/D) converter that amplifies an electrical signal output from the imaging element and converts the amplified electrical signal into a digital signal. In the imaging device, the imaging sensor captures an image of the medium, generates an analog image signal, and outputs the analog image signal, and the A/D converter converts the analog image signal to a digital scan image and outputs the digital scan image to the third processing circuit 320. Instead of the CCD, an imaging sensor employing a reduction optical system including complementary metal oxide semiconductor (CMOS) imaging elements may be used. Alternatively, a unity-magnification line sensor including CMOS or CCD imaging elements may be used.

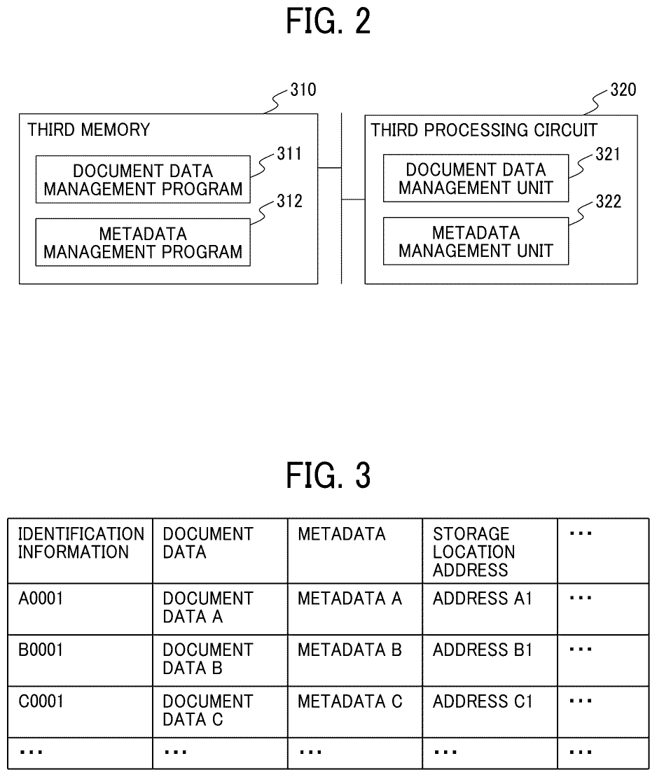

FIG. 2 is a block diagram illustrating a schematic configuration of the third memory 310 and the third processing circuit 320.

As illustrated in FIG. 2, the third memory 310 stores a document data management program 311 and a metadata management program 312. These programs are functional modules implemented by software that operates on the processor. The third processing circuit 320 reads the programs stored in the third memory 310 and operates according to the read programs, thereby functioning as a document data management unit 321 and a metadata management unit 322.

FIG. 3 is a schematic diagram illustrating a data structure of the document data table.

As illustrated in FIG. 3, the document data table stores identification information, document data, metadata, storage location address, etc., in association with each other for each document data record.

The identification information is information for identifying document data in the information processing apparatus 300. The document data is an image captured from a document, such as a receipt, an invoice, a delivery note, a business card, a contract, or a manual. The document data is transmitted from the image reading apparatus that has generated the document data at any desired timing and is stored in the document data table. When the information processing apparatus 300 is an image reading apparatus, the document data is generated by the imaging device at any desired timing and stored in the document data table. The document data may be digitized data of a document.

The metadata is data that describes document data, indicates the characteristics of the document data, and is used to handle document data effectively. The metadata includes file information and document information. The file information includes title, keywords, creation date (scan date), update date, file type, search availability, file size, number of pages, and password. The document information includes the information about the person who created or in charge of the document data, such as the name (in kanji, furigana, etc.) of the person, the name (in kanji, furigana, etc.) of the organization to which the person belongs (business entity, school, etc.), department, position, email address, telephone number, facsimile number, etc. “Furigana” is a character string indicating the pronunciation of the name. Pieces of the file information such as creation date, update date, file size, and number of pages, are generated by the image reading apparatus that generated the document data. Pieces of the file information such as title, keywords, and file type are generated by the image reading apparatus or information processing apparatus 300 that generates the document data, using character recognition technologies such as optical character recognition (OCR). Pieces of the file information such as search availability, password, and document information are set by the user of the image reading apparatus or information processing apparatus 300 that generated the document data. The search availability is automatically set based on whether the document data contains character information. The search availability may be set to be available when the document data contains character information, and may be set to be not available when the document data contains no character information. The document information may be generated using character recognition technologies such as OCR.

The storage location address is the address where the document data is stored in the first storage service 100, and is transmitted from the first storage service 100. The storage location address is the storage path in the first storage service 100 for the document data. The storage location address is usable as a file identifier (ID) that identifies the document data and the metadata in the information processing apparatus 300, the first storage service 100, and the second storage service 200.

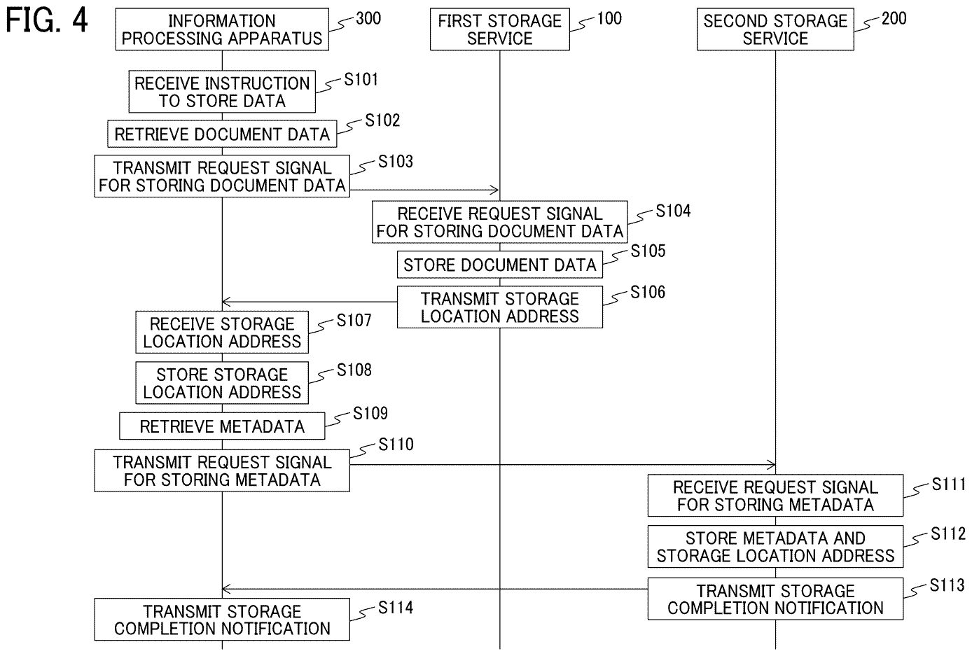

FIG. 4 is a sequence diagram of a storage process.

The operations performed by the information processing system 1 in the storage process will be described below with reference to the sequence illustrated in FIG. 4. The operations described below are executed, for example, by the processing circuits of the devices included in the information processing system 1, in cooperation with the components of the device, based on the programs prestored in the memory of the device. The storage process is executed periodically.

In step S101, the document data management unit 321 of the information processing apparatus 300 receives a storage instruction from the user to store document data and metadata in the first storage service 100 and the second storage service 200. The document data management unit 321 receives the storage instruction input by the user using the operation device 302. The storage instruction includes the identification information for identifying the document data to be stored.

In step S102, the document data management unit 321 retrieves the document data identified by the identification information specified in the storage instruction from the document data table.

In step S103, the document data management unit 321 transmits a document data storage request signal to the first storage service 100 via the third communication device 301 to store the retrieved document data in the first storage service 100. The document data storage request signal contains the retrieved document data.

In step S104, the first processing circuit 120 of the first storage service 100 receives the document data storage request signal from the information processing apparatus 300 via the first communication device 101.

In step S105, the first processing circuit 120 stores the document data included in the document data storage request signal in the first memory 110.

In step S106, the first processing circuit 120 transmits the storage location address of the document data to the information processing apparatus 300 via the first communication device 101.

In step S107, the document data management unit 321 receives the storage location address of the document data from the first storage service 100 via the third communication device 301. In this way, the document data management unit 321 transmits the document data to the first storage service 100 to store the document data in the first storage service 100, and receives the storage location address of the document data from the first storage service 100.

In step S108, the document data management unit 321 stores the storage location address in the document data table in association with the transmitted document data.

In step S109, the metadata management unit 322 retrieves the metadata corresponding to the identification information specified in the storage instruction from the document data table. In addition, the metadata management unit 322 calculates first property information of the document data and/or the metadata corresponding to the identification information specified in the storage instruction. The first property information indicates the properties of each data record. The first property information is information with which changes in the properties of the data, such as hash value, file version, and universally unique identifier (UUID) of the data, are identifiable. The first property information may be another information, such as file size or update date.

In step S110, the metadata management unit 322 transmits a metadata storage request signal to the second storage service 200 via the third communication device 301 to store the metadata, the storage location address, and the first property information in the second storage service 200. The metadata storage request signal includes the metadata and the storage location address, which are obtained, the calculated first property information, and an owner ID, which is the identification information of the information processing apparatus 300 or the user of the information processing apparatus 300 as the owner or source of the document data.

In step S111, the second processing circuit 220 of the second storage service 200 receives the metadata storage request signal from the information processing apparatus 300 via the first communication device 101.

In step S112, the second processing circuit 220 stores the metadata, the storage location address, the first property information, and the owner ID included in the metadata storage request signal in the second memory 210 in association with one another.

In step S113, the second processing circuit 220 transmits a storage completion notification signal indicating the completion of the storage of the metadata, the storage location address, the first property information, and the owner ID to the information processing apparatus 300 via the second communication device 201.

In step S114, the metadata management unit 322 receives the storage completion notification signal from the second storage service 200 via the third communication device 301, and the storage process is ended. In this way, the metadata management unit 322 transmits the metadata and storage location address to the second storage service 200 to store the data in the second storage service 200.

In step S109, the metadata management unit 322 may not calculate the first property information of the document data and the metadata, and may not transmit the first property information to the second storage service 200. In that case, the metadata management unit 322 transmits the document data to the second storage service 200, and the second processing circuit 220 of the second storage service 200 calculates the first property information for each data.

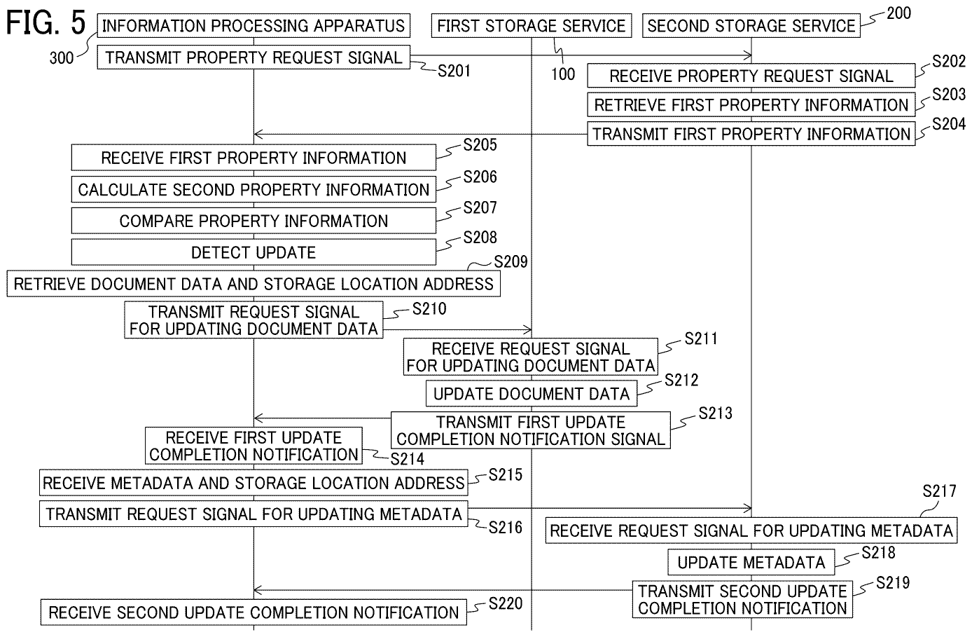

FIG. 5 is a sequence diagram of an update process.

The update process performed by the information processing system 1 will be described below with reference to the sequence illustrated in FIG. 5. The operations described below are executed, for example, by the processing circuits of the devices included in the information processing system 1, in cooperation with the components of the device, based on the programs prestored in the memory of the device. The update process is executed periodically.

In step S201, the metadata management unit 322 transmits a property request signal to the second storage service 200 via the third communication device 301 to obtain the first property information. The metadata management unit 322 transmits the property request signal to obtain the first property information of all the document data and/or the metadata stored in the first storage service 100 or the second storage service 200 by the information processing apparatus 300 or the user. The property request signal includes the storage location addresses of all the document data stored in the first storage service 100 by the information processing apparatus 300 or the user.

In step S202, the second processing circuit 220 of the second storage service 200 receives the property request signal from the information processing apparatus 300 via the first communication device 101.

In step S203, the second processing circuit 220 retrieves the first property information of all the document data and/or the metadata associated with the storage location address included in the received property request signal from the second memory 210.

In step S204, the second processing circuit 220 transmits each piece of the first property information to the information processing apparatus 300 via the second communication device 201.

In step S205, the metadata management unit 322 receives the first property information from the second storage service 200 via the third communication device 301. In this way, the metadata management unit 322 obtains the first property information of the document data stored in the first storage service 100 and/or the metadata stored in the second storage service 200 at a predetermined timing from the second storage service 200. The predetermined timing is the timing when the document data stored in the first storage service 100 or when the metadata is stored in the second storage service 200.

In step S206, the document data management unit 321 calculates second property information of the document data and/or the metadata. The second property information is of the same type as the first property information, but the timing of calculation of the second property information from the document data is different from that of the first property information. The document data management unit 321 calculates the second property information of all the document data stored in the first storage service 100 and/or all the metadata stored in the second storage service 200. It is possible that the document data and/or the metadata stored in the third memory 310 is updated at any timing. In other words, the document data management unit 321 calculates the second property information of the document data or the metadata stored in the third memory 310 at a timing different from the timing when the document data is stored in the first storage service 100 or the metadata is stored in the second storage service 200. The timing different from the timing of storage of the document data or the metadata is the timing when the document data or the metadata is from the timing when the document data is stored in the first storage service 100 or the metadata is updated after the document data or the metadata is stored or updated.

In step S207, the document data management unit 321 compares the first property information and the second property information for each document data and/or metadata, and determines whether the second property information is different from the first property information. When the second property information matches the first property information for all the document data stored in the first storage service 100 and/or all the metadata stored in the second storage service 200, the document data management unit 321 does not execute specific processing. Then, the update processing ends. In other words, the document data management unit 321 determines whether updating is necessary by comparing the first property information obtained at the predetermined timing with the second property information obtained at the timing later than the predetermined timing.

By contrast, when the second property information of any document data or any metadata is different from the first property information, in step S208, the document data management unit 321 determines that the document data or the metadata having the second property information different from the first property information is updated.

In step S209, the document data management unit 321 retrieves the document data having the second property information different from the first property information and the associated storage location address from the document data table.

In step S210, the document data management unit 321 transmits a document data update request signal to the first storage service 100 via the third communication device 301 to update the retrieved document data in the first storage service 100. The document data update request signal includes the retrieved document data and the storage location address.

In step S211, the first processing circuit 120 of the first storage service 100 receives the document data update request signal from the information processing apparatus 300 via the first communication device 101.

In step S212, the first processing circuit 120 updates the document data stored at the storage location address included in the document data update request signal with the document data included in the document data update request signal.

In step S213, the first processing circuit 120 transmits a first update completion notification signal indicating that the document data is updated to the information processing apparatus 300 via the first communication device 101.

In step S214, the document data management unit 321 receives the first update completion notification signal from the first storage service 100 via the third communication device 301.

In step S215, the metadata management unit 322 retrieves the metadata having the second property information different from the first property information and the associated storage location address from the document data table. When the second property information of the document data is different from the first property information and the second property information of the metadata is identical to the first property information, the metadata management unit 322 may generate new metadata from the updated document data.

In step S216, the metadata management unit 322 transmits a metadata update request signal to the second storage service 200 via the third communication device 301 to update the metadata and the first property information in the second storage service 200. The metadata update request signal includes the retrieved metadata, the storage location address, and the calculated secondary property information.

In step S217, the second processing circuit 220 of the second storage service 200 receives the metadata update request signal from the information processing apparatus 300 via the first communication device 101.

The second processing circuit 220 then updates the metadata associated with the storage location address included in the metadata update request signal to the metadata included in the metadata update request signal. In step S218, the second processing circuit 220 updates the first property information associated with the storage location address included in the metadata update request signal to the second property information included in the metadata update request signal. In other words, the second processing circuit 220 stores the second property information included in the metadata update request signal as new first property information in the second memory 210.

In step S219, the second processing circuit 220 transmits a second update completion notification signal indicating that the metadata and the first property information are updated to the information processing apparatus 300 via the second communication device 201.

In step S220, the metadata management unit 322 receives the second update completion notification signal from the second storage service 200 via the third communication device 301, and the update process is ended.

In this way, when the document data and metadata stored in the third memory 310 are updated, the document data management unit 321 transmits the updated document data to the first storage service 100 according to the storage location address to update the document data in the first storage service 100. Similarly, the metadata management unit 322 transmits the updated metadata to the second storage service 200 to update the metadata in the second storage service 200. It is possible that the document data or the metadata in the third memory 310 is updated at any timing. The module (application program) that updates the document data or the metadata may be a module other than the document data management unit 321 and the metadata management unit 322. The information processing apparatus 300 updates the document data and the metadata stored in the first storage service 100 and the second storage service 200, respectively, when the document data and metadata are updated in the third memory 310. This enables the appropriate control of the document data and the management data.

When the second property information of the document data differs from the first property information, the document data management unit 321 transmits the document data for which the second property information is calculated to the first storage service 100 so that the document data is updated in the first storage service 100. When the second property information of the metadata differs from the first property information, the metadata management unit 322 transmits the metadata for which the second property information is calculated to the second storage service 200 so that the metadata is updated in the second storage service 200. The information processing apparatus 300 can reduce the load in monitoring whether document data or the metadata is updated in the third memory 310 by utilizing the property information. Thus, the load in the update process can be reduced. In the information processing system 1, the first property information is stored in the second storage service 200. This allows the information processing system 1 to centrally manage information using the second storage service 200, thereby simplifying the management of information.

When either of the document data or the metadata is updated, the document data management unit 321 or the metadata management unit 322 may update both the corresponding document data in the first storage service 100 and the metadata in the second storage service 200.

Additionally, the first property information may be stored in the third memory 310 of the information processing apparatus 300, not in the second memory 210 of the second storage service 200. In this case, the process from step S201 to step S205 is omitted, and the metadata management unit 322 retrieves the first property information from the third memory 310.

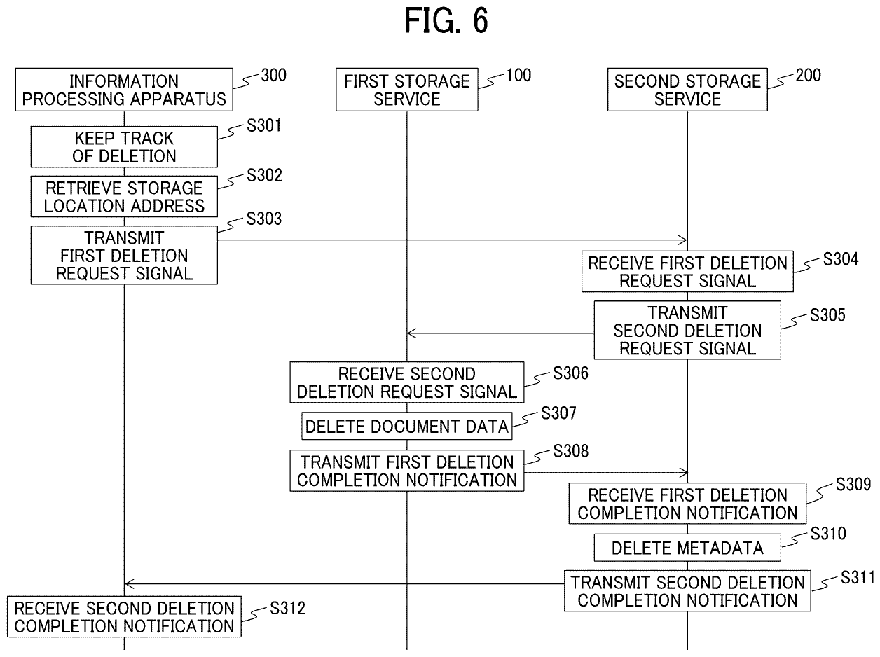

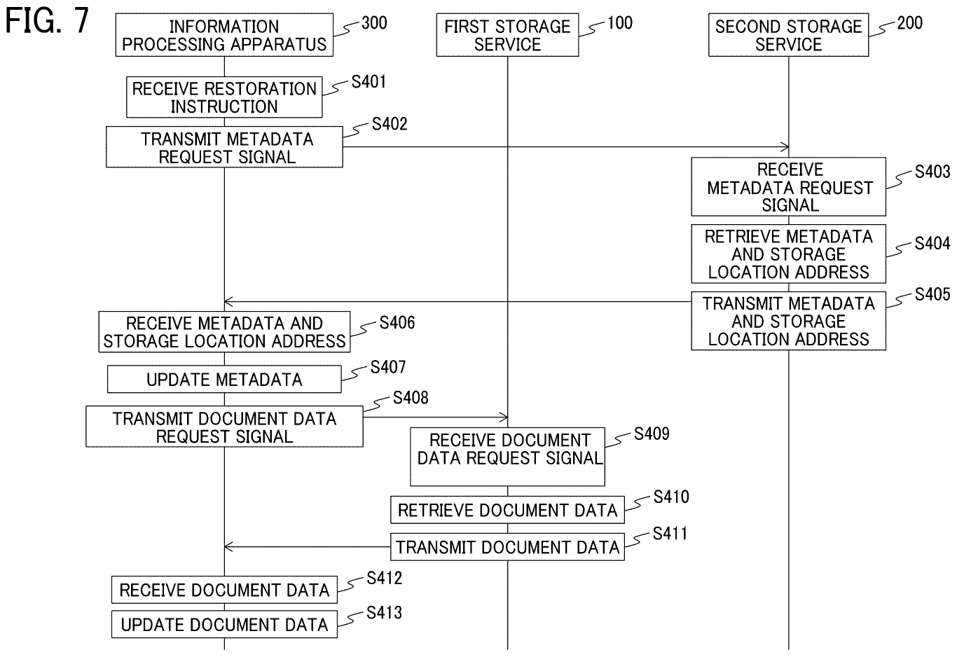

FIG. 6 is a sequence diagram of a deletion process.

The deletion process performed by the information processing system 1 will be described below with reference to the sequence illustrated in FIG. 6. The operations described below are executed, for example, by the processing circuits of the devices included in the information processing system 1, in cooperation with the components of the device, based on the programs prestored in the memory of the device. The deletion process is executed periodically.

In step S301, the document data management unit 321 monitors whether the document data stored in the third memory 310 is deleted. The document data management unit 321 determines whether any of the document data stored in the first storage service 100 has been deleted from the document data table. The document data management unit 321 will continue to monitor the document data table until the deletion of document data is deleted.

When any of the document data stored in the third memory 310 is deleted, in step S302, the document data management unit 321 retrieves, from the document data table, the storage location address associated with the document data deleted from the document data table.

In step S303, the document data management unit 321 transmits a first deletion request signal to the second storage service 200 via the third communication device 301. The first deletion request signal is a signal to delete the document data deleted from the document data table from the first storage service 100 and to delete the corresponding metadata from the second storage service 200. The first delete request signal includes the storage location address of the document data to be deleted. The first deletion request signal is an example of a request signal to request the second storage service 200 to delete document data.

In step S304, the second processing circuit 220 of the second storage service 200 receives the first deletion request signal from the information processing apparatus 300 via the second communication device 201.

In step S305, the second processing circuit 220 transmits a second deletion request signal to the first storage service 100 via the second communication device 201. The second delete request signal is a signal to delete the document data stored at the storage location address included in the first delete request signal from the first storage service 100. The second deletion request signal includes the storage location address of the document data to be deleted, that is, the storage location address included in the first deletion request signal.

In step S306, the first processing circuit 120 of the first storage service 100 receives the second deletion request signal from the second storage service 200 via the first communication device 101.

In step S307, the first processing circuit 120 deletes the document data stored at the storage location address included in the second deletion request signal from the first memory 110.

In step S308, the first processing circuit 120 transmits a first deletion completion notification signal indicating that the deletion of the document data is complete to the second storage service 200 via the first communication device 101.

In step S309, the second processing circuit 220 of the second storage service 200 receives the first deletion completion notification signal from the first storage service 100 via the second communication device 201.

In step S310, the second processing circuit 220 deletes, from the second memory 210, the metadata, the storage location address, and the first property information associated with the storage location address included in the first deletion request signal.

In step S311, the second processing circuit 220 transmits a second deletion completion notification signal indicating that the deletion of the document data and metadata is complete to the information processing apparatus 300 via the second communication device 201.

In step S312, the document data management unit 321 receives the second deletion completion notification signal from the second storage service 200 via the third communication device 301, and the deletion process is ended.

In this way, the document data management unit 321 transmits the first deletion request signal to the second storage service 200 when the document data stored in the third memory 310 is deleted. The information processing apparatus 300 does not separately transmit a request signal for deleting the document data and a request signal for deleting the metadata but transmits the first deletion request signal for deleting both the document data and the metadata to the second storage service 200. Thus, the information processing apparatus 300 reduces the processing load of the deletion process. Additionally, the information processing system 1 can centrally manage information using the second storage service 200, thereby simplifying the management of information.

Alternatively, when the document data stored in the third memory 310 is deleted, the document data management unit 321 may transmit a request signal to the first storage service 100 to delete the document data and transmit a request signal to the second storage service 200 to delete the metadata.

FIG. 7 is a sequence diagram of a restoration process.

The restoration process performed by the information processing system 1 will be described below with reference to the sequence illustrated in FIG. 7. The operations described below are executed, for example, by the processing circuits of the devices included in the information processing system 1, in cooperation with the components of the device, based on the programs prestored in the memory of the device. The restoration process is executed periodically.

In step S401, the document data management unit 321 of the information processing apparatus 300 receives a restoration instruction from the user to restore document data in the third memory 310. The document data management unit 321 receives a restoration instruction input by the user using the operation device 302.

In step S402, the metadata management unit 322 transmits a metadata request signal to the second storage service 200 via the third communication device 301 to obtain the metadata stored in the second storage service 200 and the storage location address. The metadata storage request signal includes the owner ID identifying the information processing apparatus 300 or the user of the information processing apparatus 300.

In step S403, the second processing circuit 220 of the second storage service 200 receives the metadata request signal from the information processing apparatus 300 via the second communication device 201.

In step S404, the second processing circuit 220 retrieves from the second memory 210 all the metadata associated with the owner ID included in the metadata request signal and the storage location address associated with each piece of the metadata.

In step S405, the second processing circuit 220 transmits the retrieved metadata and the storage location address to the information processing apparatus 300 via the second communication device 201.

In step S406, the metadata management unit 322 receives the metadata and the storage location addresses from the second storage service 200 via the third communication device 301. In this way, the metadata management unit 322 receives the metadata and the storage location address stored in the second storage service 200 from the second storage service 200.

In step S407, the metadata management unit 322 updates the metadata stored in the document data table in association with the received storage location address to the received metadata. In this way, the metadata management unit 322 stores the metadata received from the second storage service 200 in the third memory 310.

In step S408, the document data management unit 321 transmits a document data request signal to the first storage service 100 via the third communication device 301 to obtain the document data stored in the first storage service 100. The document data request signal includes all the storage location addresses received in step S406.

In step S409, the first processing circuit 120 of the first storage service 100 receives the document data request signal from the information processing apparatus 300 via the first communication device 101.

In step S410, the first processing circuit 120 retrieves from the first memory 110 the document data stored at each storage location address included in the document data request signal.

In step S411, the first processing circuit 120 transmits the retrieved document data and the corresponding storage location address to the information processing apparatus 300 via the first communication device 101.

In step S412, the document data management unit 321 receives the document data and the storage location address from the first storage service 100 via the third communication device 301. In this way, the document data management unit 321 receives from the first storage service 100 the document data stored in the first storage service 100 according to the storage location address received from the second storage service 200.

In step S413, the document data management unit 321 updates the document data stored in the document data table in association with the received storage location address to the received document, and ends the restoration process. In this way, the document data management unit 321 stores the document data received from the first storage service 100 in the third memory 310. Accordingly, the information processing apparatus 300 appropriately restores the document data when the document data stored in the third memory 310 is damaged.

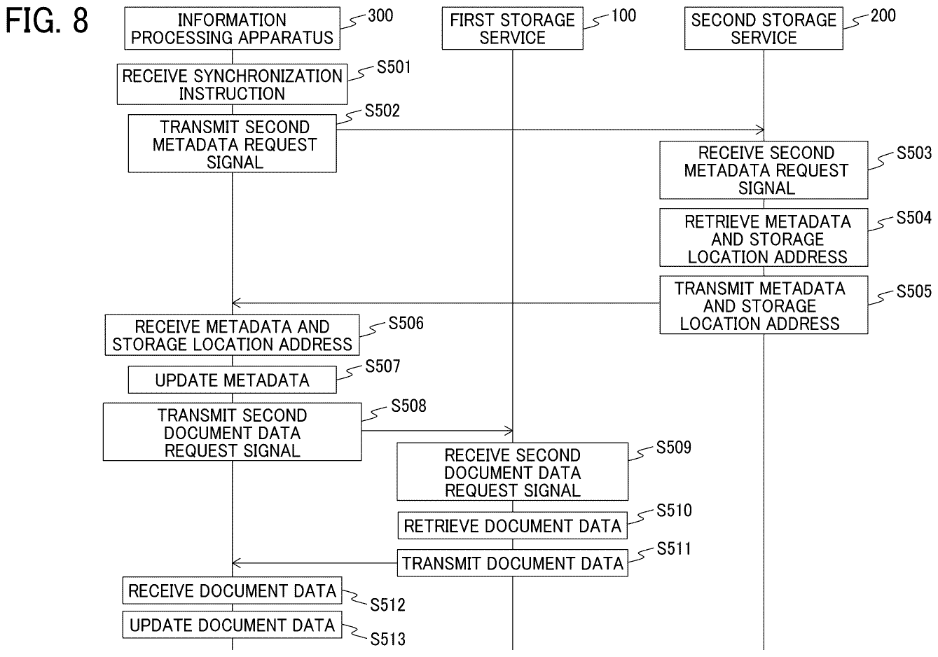

FIG. 8 is a sequence diagram of a synchronization process.

The synchronization process performed by the information processing system 1 will be described below with reference to the sequence illustrated in FIG. 8. The operations described below are executed, for example, by the processing circuits of the devices included in the information processing system 1, in cooperation with the components of the device, based on the programs prestored in the memory of the device. The synchronization process is executed periodically.

In step S501, the document data management unit 321 of the information processing apparatus 300 receives a synchronization instruction from the user to synchronize the document data stored in the third memory 310 with the document data stored in another information processing apparatus 300. In the following description, another information processing apparatus with which the information processing apparatus 300 operated by the user is to be synchronized may be referred to as a synchronization counterpart apparatus. The document data management unit 321 receives a synchronization instruction input by the user using the operation device 302. The synchronization instruction includes the owner ID identifying the synchronization counterpart apparatus or the user of the synchronization counterpart apparatus.

In step S502, the metadata management unit 322 transmits a second metadata request signal to the second storage service 200 via the third communication device 301. The second metadata request signal is a signal with which the synchronization counterpart apparatus or the user of the synchronization counterpart apparatus requests the metadata and the storage location address stored in the second storage service 200. The second metadata request signal includes the owner ID identifying the synchronization counterpart apparatus or the user of the synchronization counterpart apparatus.

In step S503, the second processing circuit 220 of the second storage service 200 receives the second metadata request signal from the information processing apparatus 300 via the second communication device 201.

In step S504, the second processing circuit 220 retrieves from the second memory 210 all the metadata stored in the second memory 210 in association with the owner ID included in the second metadata request signal and the storage location address associated with each piece of the metadata. The metadata and the storage location address stored in the second memory 210 in association with the owner ID included in the second metadata request signal are examples of second metadata and a second storage location address stored in the second storage service 200 by another information processing apparatus 300.

In step S505, the second processing circuit 220 transmits the retrieved metadata and the storage location address to the information processing apparatus 300 via the second communication device 201.

In step S506, the metadata management unit 322 receives the metadata and the storage location addresses from the second storage service 200 via the third communication device 301. In this way, the metadata management unit 322 receives from the second storage service 200 the second metadata and the second storage location address stored in the second storage service 200 by the synchronization counterpart apparatus.

In step S507, the metadata management unit 322 updates the metadata stored in the document data table in association with the received storage location address to the received metadata. In this way, the metadata management unit 322 stores the second metadata received from the second storage service 200 in the third memory 310. This allows the information processing apparatus 300 to easily store (copy) the metadata stored in the synchronization counterpart apparatus in the third memory 310.

In step S508, the document data management unit 321 transmits a second document data request signal to the first storage service 100 via the third communication device 301 to obtain the document data stored in the first storage service 100 by the synchronization counterpart apparatus or the user of the synchronization counterpart apparatus. The second document data request signal includes all the storage location addresses received in step S506.

In step S509, the first processing circuit 120 of the first storage service 100 receives the second document data request signal from the information processing apparatus 300 via the first communication device 101.

In step S510, the first processing circuit 120 retrieves from the first memory 110 the document data stored at each storage location address included in the second document data request signal.

In step S511, the first processing circuit 120 transmits the retrieved document data and the corresponding storage location address to the information processing apparatus 300 via the first communication device 101.

In step S512, the document data management unit 321 receives the document data and the storage location address from the first storage service 100 via the third communication device 301. In this way, the document data management unit 321 receives from the first storage service 100 the second document data stored in the first storage service 100 by the synchronization counterpart apparatus, according to the second storage location address received from the second storage service 200.

In step S513, the document data management unit 321 updates the document data stored in the document data table in association with the received storage location address to the received document, and ends the synchronization process. In this way, the document data management unit 321 stores the second document data received from the first storage service 100 in the third memory 310. Accordingly, the information processing apparatus 300 can easily store (copy) the document data stored in the synchronization counterpart apparatus in the third memory 310.

As described above in detail, the information processing apparatus 300 stores document data in the first storage service 100 and receives the storage location address of the document data from the first storage service 100. The information processing apparatus 300 then stores the metadata and the storage location address of the document data in the second storage service 200. This enables the information processing apparatus 300 to appropriately manage the document data through the second storage service 200 that manages the metadata.

The information processing apparatus 300 directly transmits the document data to the first storage service 100 and directly transmits the metadata to the second storage service 200. This allows the information processing system 1 to minimize the network load in transmitting and receiving document data and metadata, compared to transmitting document data to the first storage service 100 via the second storage service 200. Further, the information processing apparatus 300 can efficiently update and retrieve document data and metadata without making the user aware of the combined use of the first storage service 100 and the second storage service 200.

As described above, the second storage service 200 is provided by the provider of the information processing apparatus 300, and the first storage service 100 is provided by a provider different from the provider of the information processing apparatus 300. This allows the information processing system 1 to make the security level different between the document data and the metadata, and to flexibly set the security of each data. For example, the information processing system 1 can set the security level of the document data, which is the data of the customer, to be higher than the security level of the metadata, which is secondary data. The information processing system 1 can utilize a service offered at a low cost as the first storage service 100, thereby reducing the cost for storing document data. In addition, the system administrator of the information processing apparatus 300 can manage document data of a large data size in a large-capacity storage service provided by another company while efficiently managing metadata in a service provided by their own company.

Alternatively, as described above, the first storage service 100 is an object storage service that performs data storage and management, and the second storage service 200 may be a compute service that includes application servers and/or offers virtual machines. Also in this case, the information processing system 1 can make the security level different between the document data and the metadata, and flexibly set the security of each data. Further, the information processing system 1 can stably manage document data without being affected by changes such as the specification changes of the second storage service 200.

Also in this case, the first storage service 100 and the second storage service 200 may be provided by different providers. The information processing system 1 can make the security level different between the document data and the metadata, and can flexibly set the security of each data. In addition, the information processing system 1 can use the first storage service 100 and the second storage service 200 in any desired combination, and can select an optimal infrastructure service according to the user's needs in terms of cost, performance, etc.

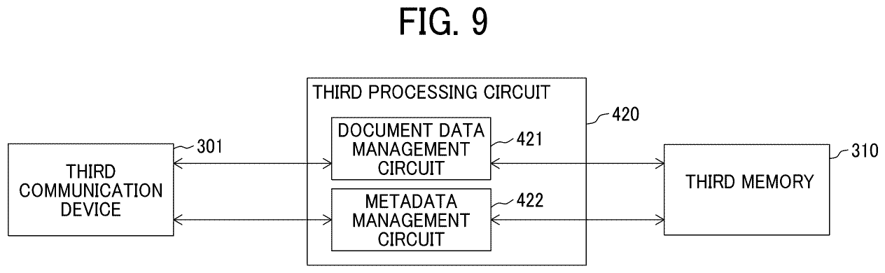

FIG. 9 is a block diagram illustrating a schematic configuration of a third processing circuit 420 in another information processing apparatus.

The third processing circuit 420 is used instead of the third processing circuit 320 and executes processes such as the storage process, the update process, the deletion process, the restoration process, and the synchronization process. The third processing circuit 420 includes a document data management circuit 421 and a metadata management circuit 422.

The document data management circuit 421 is an example of the document data management unit and functions like the document data management unit 321. The document data management circuit 421 transmits and receives data such as document data and the storage location address via the third communication device 301, and writes or reads the document data in or from the third memory 310.

The metadata management circuit 422 is an example of the metadata management unit and functions like the metadata management unit 322. The metadata management circuit 422 transmits and receives data such as metadata and the storage location address via the third communication device 301, and writes or reads the metadata and the storage location address in or from the third memory 310.

The information processing apparatus including the third processing circuit 420 can also manage document data appropriately as described above in detail.

Embodiments of the present disclosure are not limited to the above-described embodiments. For example, it is not necessary to execute all of the storage process, the update process, the deletion process, the restoration process, and the synchronization process, and any of these processes may be omitted.

The information processing apparatus 300 may request the user to log in the first storage service 100 and the second storage service 200 before the execution of the storage process, the update process, the deletion process, the restoration process, and/or the synchronization process. As a result, the information processing apparatus 300 can enhance the security level of document data and metadata.

The information processing apparatus 300 may automatically (periodically) execute the storage process, the update process, the deletion process, the restoration process, and/or the synchronization process, or may execute the processes according to an instruction from the user.

The information processing apparatus 300 may delete the document data and the metadata from the third memory 310 after the document data and the metadata stored in the third memory 310 are stored in the first storage service 100 and the second storage service 200, respectively. In addition, when a search instruction is received from the user, the information processing apparatus 300 may request the second storage service 200 to search for the metadata stored in the second storage service 200. The information processing apparatus 300 transmits a search request signal including a keyword, etc., designated by the user to the second storage service 200. The second storage service 200 receives the search request signal and transmits the metadata including the keyword, etc., included in the received search request signal and the storage location address associated with the metadata to the information processing apparatus 300. The information processing apparatus 300 receives, from the first storage service 100, the document data stored at the storage location address received from the second storage service 200. In this case, the second storage service 200 may receive the document data stored at the storage location address associated with the metadata including the keyword, etc., from the first storage service 100 and transmit the document data to the information processing apparatus 300 together with the metadata.

In addition, when receiving a viewing instruction from the user, the information processing apparatus 300 may request the first storage service 100 and the second storage service 200 to allow the document data and the metadata to be viewed, respectively. The information processing apparatus 300 transmits a first viewing request signal including the storage location address of document data designated by the user to the second storage service 200. The second storage service 200 receives the first browsing request signal and transmits the metadata corresponding to the storage location address included in the received first browsing request signal to the information processing apparatus 300. The information processing apparatus 300 transmits a second viewing request signal including the storage location address of the document data designated by the user to the first storage service 100. The first storage service 100 receives the second browsing request signal and transmits the document data corresponding to the storage location address included in the received second browsing request signal to the information processing apparatus 300. In this case, the second storage service 200 may receive the document data stored at the storage location address included in the first browsing request signal from the first storage service 100, and transmit the document data to the information processing apparatus 300 together with the metadata. The information processing apparatus 300 displays the received document data and the metadata on the display device 303.

The information processing apparatus 300 may determine the document data and the metadata to be viewed based on the first property information and the second property information. In this case, the metadata management unit 322 transmits a property request signal to the second storage service 200 to obtain the first property information of the document data and/or the metadata to be viewed, and receives the first property information from the second storage service 200. The document data management unit 321 calculates the second property information of the document data and/or the metadata to be viewed, stored in the third memory 310. The document data management unit 321 compares the first property information with the second property information to determine whether the second property information is different from the first property information. When the second property information matches the first property information, the information processing apparatus 300 displays the document data and the metadata stored in the third memory 310 on the display device 303. By contrast, when the second property information is different from the first property information, the information processing apparatus 300 receives the document data and the metadata from the first storage service 100 and the second storage service 200, respectively, and displays the document data and the metadata on the display device 303. This allows the information processing apparatus 300 to appropriately display the document data and the metadata that the user wishes to view while minimizing the network load.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. An information processing apparatus comprising:
a memory that stores document data and metadata of the document data in association with each other; and
circuitry configured to:
transmit the document data to a first storage service to store the document data in the first storage service;
receive a storage location address of the document data from the first storage service; and
transmit the metadata and the storage location address to a second storage service to store the metadata and the storage location address in the second storage service,
wherein the second storage service is different from the first storage service.

2. The information processing apparatus according to claim 1,
wherein, when the document data and the metadata stored in the memory are updated, the circuitry is configured to:
transmit the updated document data to the first storage service in accordance with the storage location address and request the first storage service to update the document data stored in the first storage service, and
transmit the updated metadata to the second storage service to request the second storage service to update the metadata stored in the second storage service.

3. The information processing apparatus according to claim 1, wherein the circuitry is configured to:
monitor whether the document data stored in the memory is deleted, and
transmit, to the second storage service, a request signal for requesting deletion of the document data from the first storage service when the document data is deleted from the memory.

4. The information processing apparatus according to claim 1, wherein the circuitry is configured to:
receive the metadata and the storage location address stored in the second storage service from the second storage service; and
receive the document data stored in the first storage service from the first storage service in accordance with the storage location address received from the second storage service.

5. The information processing apparatus according to claim 1, wherein the circuitry is configured to:
receive, from the second storage service, second metadata and a second storage location address each stored in the second storage service by another information processing apparatus;
store the received second metadata in the memory;
receive, from the first storage service, second document data stored in the first storage service by the another information processing apparatus according to the received second storage location address; and
store the second document data in the memory.

6. The information processing apparatus according to claim 1, wherein the circuitry is configured to:
obtain, from the second storage service, first property information of the document data stored in the first storage service at a predetermined timing;
calculate second property information of the document data stored in the memory at a timing different from the predetermined timing; and
when the second property information is different from the first property information, transmit the document data for which the second property information is calculated to the first storage service to request the first storage service to update the document data.

7. The information processing apparatus, according to claim 1, wherein
the second storage service is provided by a provider of the information processing apparatus, and
the first storage service is provided by another provider different from the provider of the information processing apparatus.

8. The information processing apparatus according to claim 1, wherein the first storage service is an object storage service, and the second storage service is a compute service.

9. The information processing apparatus according to claim 8,
wherein the first storage service and the second storage service are provided by different providers.

10. An information processing method comprising:
storing document data and metadata of the document data in association with each other;
transmitting the document data to a first storage service to store the document data in the first storage service;
receiving a storage location address of the document data from the first storage service; and
transmitting the metadata and the storage location address to a second storage service to store the metadata and the storage location address in the second storage service,
wherein the second storage service is different from the first storage service.

11. A computer-readable, non-transitory recording medium storing a plurality of instructions which, when executed by one or more processors, causes the one or more processors to execute a process, the process comprising:
storing document data and metadata of the document data in association with each other;
transmitting the document data to a first storage service to store the document data in the first storage service; receiving a storage location address of the document data from the first storage service; and
transmitting the metadata and the storage location address to a second storage service to store the metadata and the storage location address in the second storage service,
wherein the second storage service is different from the first storage service.
